(19) United States
(12) Patent Application Publication
(10) Pub. No.: US 2014/0122905 A1
(43) Pub. Date: May 1, 2014

(54) POWER START-UP DEVICE AND POWER START-UP METHOD

(71) Applicants: INVENTEC (PUDONG) TECHNOLOGY CORPORATION, Shanghai (CN); INVENTEC CORPORATION, Taipei (TW)

(72) Inventor: Chia-Hsiang Chen, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/789,118

(22) Filed: Mar. 7, 2013

(30) Foreign Application Priority Data
Oct. 30, 2012 (CN) 201210422486.9

(51) Int. Cl. G06F 1/26

(52) U.S. Cl. CPC G06F 1/26
USPC 713/300

(57) ABSTRACT

A power start-up device and a power start-up method are provided, wherein the power start-up device comprises a detecting module, a status control module, a prompt module and a power management module. The detecting module is used for detecting a power actuating signal caused by a power switch. The status control module is coupled to the detecting module, for receiving the power actuating signal, and determining a number of times of pressing the power switch and a period of pressing the power switch, in order to generate a prompt adjustment signal and a power control signal. The prompt module is coupled to the status control module, for receiving the prompt adjustment signal in order to send out and transform a user prompt signal. The power management module is coupled to the status control module, for controlling a power supply of a computer system according to the power control signal.

### CROSS-REFERENCE TO RELATED APPLICATIONS

This non-provisional application claims priority under 35 U.S.C. §119(a) on Patent Application No(s). 201210422486.9 filed in China on Oct. 30, 2012, the entire contents of which are hereby incorporated by reference.

### BACKGROUND OF THE INVENTION

1. Technical Field of the Invention

The disclosure relates to a computer device and more particularly to a power start-up device and its power start-up method of a computer system.

2. Description of the Related Art

In a present computer system (e.g. a personal computer or a server system) design, a control circuit is used for detecting whether the power switch is turned on, so that through the power switch users can directly control whether power is supplied to the computer system. Generally, when the computer is under a standby or shutdown status, a user can press the power switch to wake up the power supply for supplying power. When the computer is turned on, the user can shut down the computer by pressing the power switch again.

However, when the user is using the computer, the power switch may be pressed accidentally to cause the computer shut down unexpectedly. It is risky for the computer system management and even causes serious damages to the software and hardware in the computer, so that the computer may not be able to restart again. In some computer systems, another startup switch is disposed for performing double confirmations, or complicated structures are used for compose the power switch, in order to avoid that the power switch is pressed accidentally. However, it is inconvenient for the user to operate the computer system.

### SUMMARY OF THE INVENTION

The disclosure relates to a power start-up device is adapted to a computer system. The power start-up device comprises a detecting module, a status control module, a prompt module and a power management module. The detecting module is used for detecting a power actuating signal caused by a power switch. The status control module is coupled to the detecting module, for receiving the power actuating signal to determine a number of times of pressing the power switch and a period of pressing the power switch, so as to generate a prompt adjustment signal and a power control signal. The prompt module is coupled to the status control module, for receiving the prompt adjustment signal to send out and transform a user prompt signal. The power management module is coupled to the status control module, for controlling a power supply of the computer system according to the power control signal.

In an embodiment of the disclosure, when the power actuating signal is enabled for a period which does not exceed a first pressing time, the status control module in a first prompt period generates and transmits the prompt adjustment signal in a first mode to the prompt module, and detects whether the power actuating signal is enabled, so as to enable the power control signal.

In an embodiment of the disclosure, when the power actuating signal is not enabled in the first prompt period, the status control module in a second prompt period generates and transmits the prompt adjustment signal in a second mode to the prompt module, and detects whether the power actuating signal is enabled, so as to enable the power control signal.

In an embodiment of the disclosure, the power start-up device further comprises a startup controlling module and a switching unit. The startup controlling module is coupled to the detecting module and the power management module, for receiving the power actuating signal, taking the power actuating signal as the power control signal, and transmitting the power control signal to the power management module. The switching unit is coupled to the detecting module and the status control module, for transmitting the power actuating signal to the status control module or the startup controlling module according to a mode selecting signal.

The disclosure relates to a power start-up method is adapted to a computer system. The power start-up method comprises following steps. A power actuating signal caused by a power switch is detected. A number of times of pressing the power switch and a period of pressing the power switch are determined, according to the power actuating signal so as to generate a prompt adjustment signal and a power control signal. A user prompt signal is sent out and transformed according to the prompt adjustment signal. A power supply of the computer system is controlled according to the power control signal.

### BRIEF DESCRIPTION OF THE DRAWINGS

The disclosure will become more fully understood from the detailed description given herein below for illustration only, and thus does not limit the disclosure, wherein:

FIG. 1 is a functional block diagram of a power start-up device according to a first embodiment of the disclosure;

FIG. 2 is a flow chart of a power start-up method according to the first embodiment of the disclosure;

FIG. 3 is a functional block diagram of the power start-up device according to a second embodiment of the disclosure;

FIG. 4 is a flow chart of the power start-up method according to the second embodiment of the disclosure; and

FIG. 5 is a flow chart of the power start-up method according to a third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

When a computer system is operating, the power switch may be pressed accidentally by a user to cause the computer system to be turned off unexpectedly. Even though by disposing another startup switch to perform double confirmations to shut down the computer system, it can reduce a probability the computer system being turned off accidentally due to the accidental pressing of the power switch, additional control circuits have to be designed to support such a method which will increase the costs. Therefore, in the disclosure, a number of times and a length of time the power switch is being pressed are both taken into considerations for confirming whether the user is turning off the computer system purposely or accidentally, when the power switch is pressed, in order to reduce a probability the computer system is being turned off accidentally.

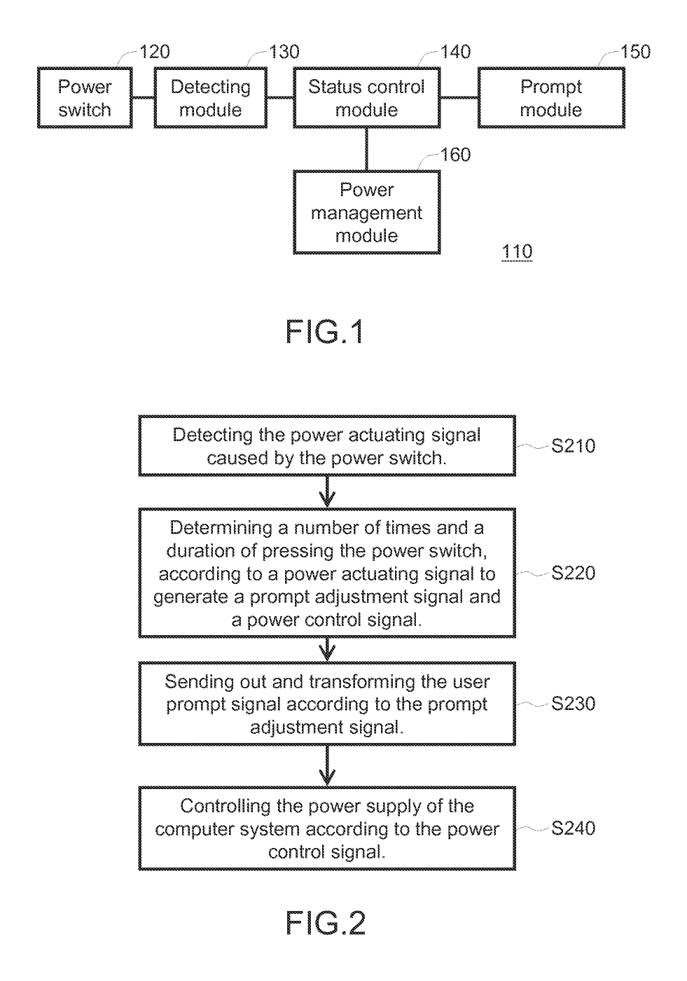

FIG. 1 is a functional block diagram of a power start-up device 110 according to a first embodiment of the disclosure. The power start-up device 110 comprises a power switch 120, a detecting module 130, a status control module 140, a prompt module 150 and a power management module 160. The power start-up device 110 can be adapted to a computer system. The computer system is, for examples, a laptop, a personal computer, a server, a tablet computer or a workstation, etc., or any electronic device with a power supply controlled by pressing the power switch. The detecting module 130 is coupled to the power switch 120, for detecting a power actuating signal caused by the power switch 120. The power start-up device 110 can be embodied through a programmable logic device (PLD) on a motherboard of the computer system. But it should not be construed as a limitation to the embodiments of the disclosure. The power switch 120 is a switch disposed on a case carrying the motherboard of the computer system, for controlling the power supply of the computer system.

The status control module 140 is coupled to the detecting module 130, for receiving the power actuating signal and according to the power actuating signal, determining a number of times of pressing the power switch 120 and a period of pressing the power switch 120, so as to generate a prompt adjustment signal and a power control signal.

The prompt module 150 is coupled to the status control module 140, for receiving the prompt adjustment signal, and sending out and transforming a user prompt signal according to the prompt adjustment signal. The user prompt signal is a variation of sound from the computer system, or a variation of light signal shown on the computer system. The power management module 160 is coupled to the status control module 140, for controlling the power supply of the computer system according to the power control signal.

When the detecting module 130 detects that the power switch 120 is enabled, the status control module 140 adjusts the operations of the prompt module 150 and the power management module 160 according to the current system status. For example, when the system is under an initial status (i.e. the status which the power actuating signal has not appeared after the system booting is complete), and when the detecting module 130 detects that the power switch 120 is pressed, the status control module 140 determines the corresponding period of pressing the power switch 120, according to the current power actuating signal.

When the period of pressing the power switch 120 does not exceed a first pressing time (e.g. one second), because the period of pressing the power switch 120 is shorter than the first pressing time of one second, the current condition of the power switch 120 may be regarded as an accidental pressing by the status control module 140. Herein, in order to confirm whether the computer system should be turned off, or to conform whether the current condition represents the accidental pressing, the status control module 140 in a first prompt period (e.g. five seconds) generates and transmits the prompt adjustment signal in a first mode to the prompt module 150. A period of the first prompt period can be set by the user or by the manufacturer of the power start-up device 110. The prompt module 150 can adjust the prompt signal according to the prompt adjustment signal.

The prompt module 150 can be embodied through a light emitting diode display module. Therefore, the user can notice the prompt signal through the light emitting condition of the light emitting diodes. The first mode can be a preset frequency (e.g. 60 Hz) of the light emitting diode flashing. In other words, the prompt adjustment signal in the first mode can control the prompt signal to become an adjustment signal of the light emitting diode light signal having a specific flashing frequency.

If an accidental pressing of the power switch 120 causes the power actuating signal, the prompt module 150 sends out the prompt signal in the first mode (e.g. the flashing signals of the light emitting diode) to notify the user, who presses the power switch 120 accidentally, to immediately keep away from the power switch 120.

When the detecting module 130 in the first prompt period, for example, five seconds, detects once again that the power actuating signal is enabled, that is, the power switch 120 is pressed twice in the first prompt period, the status control module 140 determines that the computer system is commanded to shut down, according to the adjacent two power actuating signals. Therefore, the status control module 140 enables the power control signal and sends the power control signal to the power management module 160 in order to shut down the computer system by interrupting the power supply of the computer system. The adjacent two power actuating signals are respectively the previous power actuating signal caused by pressing the power switch 120 for less than the first pressing time, and the current power actuating signal caused in the first prompt period.

When the power actuating signal is not detected again in the first prompt period (for example, five seconds), the status control module 140 generates and transmits the prompt adjustment signal in a second mode to the prompt module 150 in a second prompt period (e.g. the next five seconds) after the first prompt period is end.

The prompt adjustment signal in the second mode is, for example, an adjustment signal which can transform the prompt signal to the light emitting diode light signal with another flashing frequency (e.g. 120 Hz) different from the flashing frequency in the first mode. In this embodiment, as comparing with the first mode prompt adjustment signal, the second mode prompt adjustment signal is displayed more urgently, so that the user can distinctly distinguish the first mode from the second mode.

Similarly, when the detecting module 130 detects once again that the power actuating signal is enabled, the status control module 140 determines that the computer system is commanded to shut down, through the adjacent two power actuating signals (i.e. the previous power actuating signal caused by pressing the power switch 120 for less than the first pressing time, and the current power actuating signal in the second prompt period). Therefore, the status control module 140 enables the power control signal and sends the power control signal to the power management module 160 in order to shut down the computer system by interrupting the power supply of the computer system.

In contrast, when the status control module 140 in the second prompt period does not detect again that the power actuating signal is enabled, the status control module 140 considers that the single enabled power actuating signal, which the pressing time does not exceed the first pressing time, is merely generated by the accidental pressing. Therefore, the status control module 140 further resets the prompt adjustment signal to control the prompt signal of the prompt module 150 to restore to an initial status before the first prompt period.

Therefore, through the status control module 140 and the prompt module 150, multiple confirmations can be achieved when the power switch 120 is pressed, so to avoid that the computer system is shut down unexpectedly because of the accidental pressing.

In the disclosure, the first pressing time, the first prompt period, the second prompt period, the first mode and the second mode can be set by the user or by the manufacturer of the power start-up device 110.

FIG. 2 is a flow chart of a power start-up method according to the first embodiment of the disclosure. Please refer to FIGS. 1 and 2 at the same time. In step S210, the detecting module 130 detects the power actuating signal caused by the power switch 120. In step S220, the status control module 140 determines a number of times of pressing the power switch 120 and a period of pressing the power switch 120, according to the power actuating signal so as to generate the prompt adjustment signal and the power control signal. In step S230, the prompt module 150 sends out and transforms the user prompt signal according to prompt adjustment signal. In step S240, the power management module 160 controls the power supply of the computer system according to the power control signal. Other embodied details can be referred to in the above embodiment and therefore will not be described herein again.

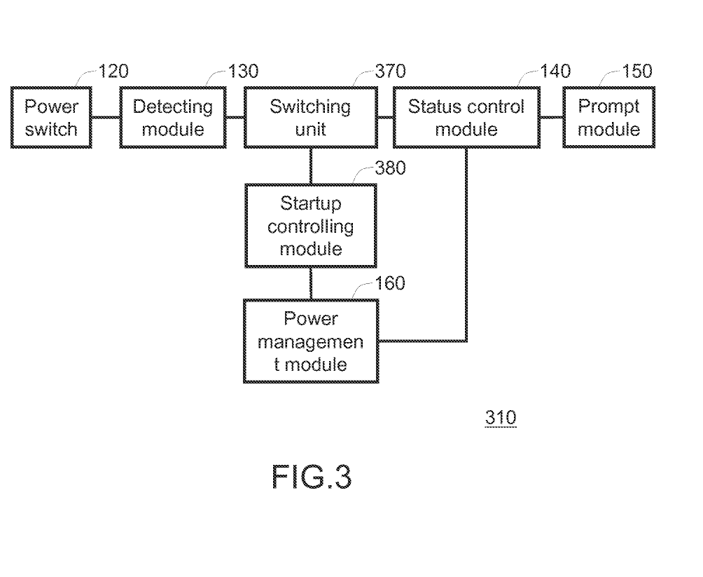

FIG. 3 is a functional block diagram of a power start-up device 310 according to a second embodiment of the disclosure. The difference between this embodiment and the previous embodiment is that the power start-up device 310 further comprises a startup controlling module 380 and a switching unit 370. The startup controlling module 380 is coupled to the detecting module 130 and the power management module 160, for receiving the power actuating signal, transforming the power actuating signal to the power control signal, and transmitting the power control signal to the power management module 160. The startup controlling module 380 is, for example, a control and detection module, such as a southbridge control chip. A power actuating signal appears when the computer system is shut down, and this power actuating signal is considered as an actuating signal generated by the startup of the computer system. Herein, the detecting module 130 sends the power actuating signal to the startup controlling module 380 directly, and the startup controlling module 380 notifies the power management module 160 to boot the computer system.

The switching unit 370 is coupled to the detecting module 130, the status control module 140 and the startup controlling module 380. The switching unit 370 determines whether to transmit the power actuating signal to the status control module 140 or to the startup controlling module 380, according to a mode selecting signal. The mode selecting signal is, for example, a signal transmitted to the switching unit 370 from a baseboard management controller (BMC) (not shown in the drawing) disposed outside the power start-up device 310, and is used for switching whether the power actuating signal is transmitted through the startup controlling module 380 directly to the power management module 160, or is transmitted through the status control module 140 to the power management module 160.

In other words, the transmission path of the switching unit 370 can be switched through the mode selecting signal. When the computer system is turned on and when the power actuating signal is received, the power start-up device 310 can shut down the computer system directly or transmit the power actuating signal to the status control module 140. When receiving the power actuating signal, to the status control module 140 determines whether an accidental pressing occurs, according to the power actuating signal.

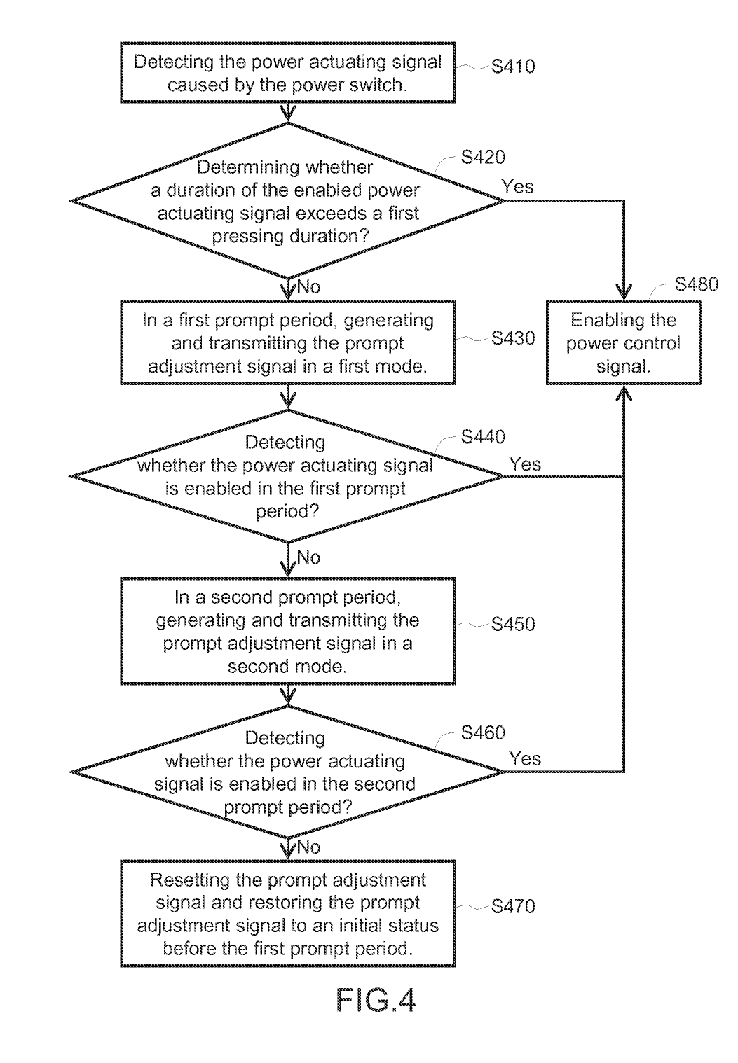

FIG. 4 is a flow chart of a power start-up method according to the second embodiment of the disclosure. Please refer to FIGS. 3 and 4 at the same time. In step S410, the detecting module 130 detects the power actuating signal caused by the power switch 120. In step S420, the status control module 140 determines whether the period of enabling the power actuating signal exceeds a first pressing time. When the period of enabling the power actuating signal exceeds the first pressing time, the power control signal is enabled (step S480) after the step S420, in order to shut down the computer system. When the period of enabling the power actuating signal does not exceed the first pressing time, the status control module 140 in the first prompt period generates and transmits the prompt adjustment signal in a first mode to the prompt module 150 (step S430) after the step S420.

In step S440, the status control module 140 detects whether the power actuating signal is enabled in the first prompt period. When the power actuating signal is enabled, the power control signal is enabled (step S480) after the step S440, in order to shut down the computer system. In contrast, when the power actuating signal is not enabled, the status control module 140 generates and transmits the second mode prompt adjustment signal to the prompt module 150 in the second prompt period (step S450) after the step S440. In step S460, the status control module 140 detects whether the power actuating signal is enabled, in the second prompt period. When the power actuating signal is enabled, the power control signal is enabled (step S480) after the step S460, in order to shut down the computer system. When the power actuating signal is not enabled yet, the status control module 140 resets the prompt adjustment signal (step S470) after the step S460, so as to restore the prompt adjustment signal to an initial status before the first prompt period. In step S480, the status control module 140 enables the power control signal and transmits the enabled power control signal to the power management module 160 in order to shut down the computer system.

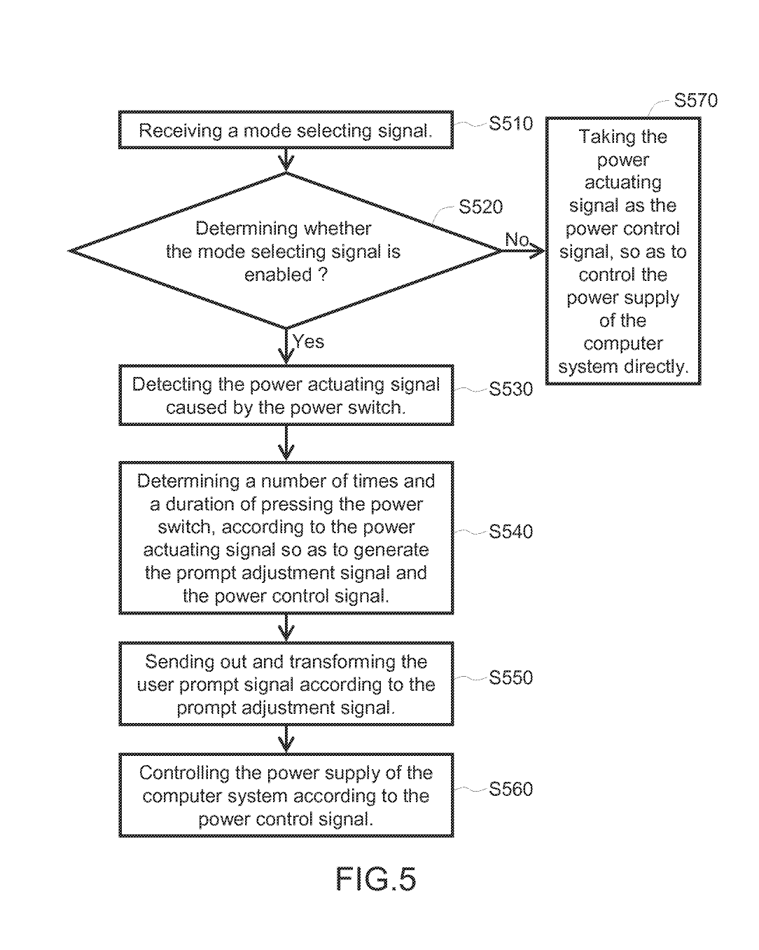

FIG. 5 is a flow chart of a power start-up method according to a third embodiment of the disclosure. Please refer to FIGS. 3 and 5 at the same time. In step S510, the switching unit 370 receives the mode selecting signal. In step S520, it is performed to determine the mode selecting signal is enabled. When the mode selecting signal is enabled, the detecting module 130 detects the power actuating signal of the power switch 120 (step S530) after the step S520. When the mode selecting signal is not enabled (i.e. disabled), the startup controlling module 380 transforms the power actuating signal to the power control signal after the step S520, in order to control the power supply of the computer system directly (step S570).

In step S540, the status control module 140 determines a number of times of pressing the power switch 120 and the period of pressing the power switch 120, according to the power actuating signal, in order to generate the prompt adjustment signal and the power control signal. In step S550, the prompt module 150 sends out and transforms the user prompt signal according to the prompt adjustment signal. In step S560, the power management module 160 controls the power supply of the computer system according to the power control signal.

In the power start-up device and its power start-up method provided by the disclosure, the status control module determines a number of times of pressing the power switch and the period of pressing the power switch, so as to determine that the computer system is commanded to shut down, or that the power switch is pressed accidentally. Then, the prompt module can notify the user whether the power switch of the computer system is pressed purposely or accidentally, so that the user can shut down the computer system properly, according to a specific number of times of pressing the power switch and the period of pressing the power switch. Thus, it may be avoided to press the power switch accidentally, and the risk for the computer system being shut down accidentally may be reduced.

What is claimed is:

1. A power start-up device, adapted to a computer system, and comprising:
a detecting module, for detecting a power actuating signal caused by a power switch;
a status control module, coupled to the detecting module, for receiving the power actuating signal to determine a number of times of pressing the power switch and a period of pressing the power switch, to generate a prompt adjustment signal and a power control signal;
a prompt module, coupled to the status control module, for receiving the prompt adjustment signal to send out and transform a user prompt signal; and
a power management module, coupled to the status control module, for controlling a power supply of the computer system according to the power control signal.

2. The power start-up device according to claim 1, when the power actuating signal is enabled for a period which does not exceed a first pressing time, the status control module in a first prompt period generates and transmits the prompt adjustment signal in a first mode to the prompt module, and detects whether the power actuating signal is enabled, so as to enable the power control signal.

3. The power start-up device according to claim 2, when the power actuating signal is not enabled in the first prompt period, the status control module in a second prompt period generates and transmits the prompt adjustment signal in a second mode to the prompt module, and detects whether the power actuating signal is enabled, so as to enable the power control signal.

4. The power start-up device according to claim 3, when the power actuating signal is not enabled in the second prompt period, the status control module resets the prompt adjustment signal and restores the prompt adjustment signal to an initial status before the first prompt period.

5. The power start-up device according to claim 1, further comprising:
a startup controlling module, coupled to the detecting module and the power management module, for receiving the power actuating signal, taking the power actuating signal as the power control signal, and transmitting the power control signal to the power management module; and
a switching unit, coupled to the detecting module, the status control module and the startup controlling module, for transmitting the power actuating signal to the status control module or the startup controlling module according to a mode selecting signal.

6. A power start-up method, adapted to a computer system, and comprising:
detecting a power actuating signal caused by a power switch;
determining a number of times of pressing the power switch and a period of pressing the power switch, according to the power actuating signal, so as to generate a prompt adjustment signal and a power control signal;
sending out and transforming a user prompt signal according to the prompt adjustment signal; and
controlling a power supply of the computer system according to the power control signal.

7. The power start-up method according to claim 6, wherein the step of generating the prompt adjustment signal and the power control signal according to the power actuating signal, comprises:
enabling the power control signal when a period of enabling the power actuating signal exceeds a first pressing time.

8. The power start-up method according to claim 6, wherein the step of generating the prompt adjustment signal and the power control signal according to the power actuating signal, comprises:
generating and transmitting the prompt adjustment signal in a first mode in a first prompt period so as to transform the user prompt signal into the first mode, when a period of enabling the power actuating signal does not exceed a first pressing time; and
detecting whether the power actuating signal being enabled in the first prompt period in order to enable the power control signal.

9. The power start-up method according to claim 8, wherein the step of generating the prompt adjustment signal and the power control signal according to the power actuating signal, further comprises:
generating and transmitting the prompt adjustment signal in a second mode in a second prompt period so as to transform the user prompt signal into the second mode, when the power actuating signal is not enabled in the first prompt period;
detecting whether the power actuating signal is enabled in the second prompt period, so as to enable the power control signal; and
resetting the prompt adjustment signal and restoring the prompt adjustment signal to an initial status before the first prompt period, when the power actuating signal is not enabled in the second prompt period.

10. The power start-up method according to claim 6, further comprising:
receiving a mode selecting signal;
determining a number of times of pressing the power switch and a period of pressing the power switch, according to the power actuating signal so as to generate the prompt adjustment signal and the power control signal when the mode selecting signal is enabled; and
taking the power actuating signal as the power control signal to directly control the power supply of the computer system, when the mode selecting signal is disabled.
